(19) United States
(12) Patent Application Publication
(10) Pub. No.: US 2004/0260629 A1
(43) Pub. Date: Dec. 23, 2004

(54) Disbursement processing system with integrated Office of Foreign Asset Control compliance

(75) Inventor: Andrew J. Mintzer, Fort Salonga, NY (US)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH

(21) Appl. No.: 10/465,421

(22) Filed: Jun. 19, 2003

(51) Int. Cl. G06F 17/60

(52) U.S. Cl. 705/30

(57) ABSTRACT

A method for processing a disbursement transaction received from an accounting system includes verification that the payee of the disbursement transaction is not a Specially Designated National or Blocked Person, as designated by the Treasury Department's Office of Foreign Asset Control. The method includes receiving a plurality of character strings, each representing a Specially Designated National or Blocked Person. A plurality of alternative character strings are developed, each being a variation of the character string representing a Specially Designated National or Blocked Person. A comparison file includes a plurality of comparison character strings which comprise each of the plurality of Specially Designated National character strings and each of the plurality of alternative character strings. A disbursement transaction is received from the accounting system and an output payment is generated only if a payee character string of the disbursement transaction does not match any of the comparison character strings.

### TECHNICAL FIELD

The present invention relates generally to automated disbursement processing systems and in particular to automated disbursement processing systems that verify Office of Foreign Asset Control compliance.

### BACKGROUND OF THE INVENTION

Periodically the United States Treasury's Office of Foreign Asset Control publishes lists of Specially Designated Nationals and Blocked Persons (herein after referred to as Specially Designated Nationals). Each Specially Designated National on the list is wither a person or other entity who's assets have been blocked or frozen by the Unites States Treasury.

There exist various penalties for releasing such assets and conducting business with such Specially Designated Nationals. To avoid such penalties, many businesses and financial institutions obtain the lists of Specially Designated Nationals and compare the payee of each disbursement to such list to assure compliance.

Several problems exists. First, due to the large numbers of disbursements made, manual comparison of each payee to the list can be time consuming and error prone at best.

Secondly, automated comparison of an ASCII representation of the payee to an ASCII representation of each Specially Designated National may be quick, but is error prone and would even miss such obvious matches as “Fidel Castro” to “fidel castro”. As such electronic comparisons require more complex logic to detect substantive matches even when there is not an ASCII direct match. Most compliance departments of companies and financial institutions have developed their own proprietary matching algorithms to assure their compliance with the Treasury Department rules without generating excessive false positive matches.

Thirdly, many companies and financial institutions use disbursement systems to automate their disbursement processes. Such systems may utilize software for securely receive disbursement transactions from the company's or financial institution's back end financial software systems. To effect such disbursements, the systems generate secure electronic payments such as wire transfers, ACH payment transactions, and other real time settlements and generate negotiable draft files for secure printing on a laser printer. Modifying either the back end financial software systems or the disbursement systems to incorporate the proprietary matching algorithms is a time consuming task.

As such, what is needed is an automated disbursement system that provides for verification that each payee is not a Specially Designated National utilizing one of a plurality of proprietary matching algorithms.

### SUMMARY OF THE INVENTION

A first aspect of the present invention is to provide a method of receiving a disbursement transaction from an accounting system and verifying that a payee character string of the disbursement transaction is not a Specially Designated National. The method comprises first obtaining a list of a plurality of Specially Designated Nationals. Each Specially Designated National being represented by a Specially Designated National character string. Then a plurality of alternative character strings are developed. Each alternative character string represents the Specially Designated National from which it was derived. A comparison file is developed. The comparison file comprises a plurality of comparison character strings organized as a main table (or list) and an alternate table (or list). The plurality of comparison character strings comprise each of the plurality of Specially Designated National character strings in the main list and each of the plurality of alternative character strings in the alternate list. There may be zero or more alternative character strings corresponding to each Specially Designated National character string.

A disbursement transaction is received from the accounting system. The payee character string of the disbursement transaction is compared to each comparison character strings to determining that the payee is not a Specially Designated National (e.g. is an authorized payee)—only if the payee character string does not match any of the comparison character strings (e.g. only if the payee character string is unique of all of the comparison character strings). An output payment corresponding to the disbursement transaction is generated in response to determining that the payee is not a Specially Designated National (e.g. that the payee is an authorized payee). A match transaction is generated if the payee character string matches any of the comparison character strings.

The method may further include receiving an override transaction in response to generating the match transaction if the disbursement can be manually authorized. In which case, the output payment corresponding to the disbursement transaction is generated in response to receiving the override transaction.

The process of receiving the override transaction may comprise: i) receiving a login request from a remote override system; ii) authenticating an authorized user of the remote override system; ii) providing a manual data entry document including the match transaction to the override system; and ii) receiving the override transaction back from the remote override system.

Exemplary output payments include wire transfers, Automated Clearing House compliant transactions, other real time electronic settlements, and a printed draft effected by generating an image file comprising an image of a negotiable document for printing on a laser printer.

A second aspect of the present invention is to provide a method of processing a disbursement transaction received from an accounting system. The method may comprise obtaining a list of a plurality of Specially Designated Nationals. Each Specially Designated National may be represented by a Specially Designated National character string. A plurality of alternative character strings are developed for each Specially Designate National character string. Each of the plurality of alternative character strings represents the Specially Designated National from which it was derived. A comparison file is developed. The comparison file includes a plurality of comparison character stings. The plurality of comparison character strings comprise each of the plurality of Specially Designated National character strings in a main list of the comparison file and each of the plurality of alternative character strings in an alternate list of the comparison file. A disbursement transaction is received from the accounting system and an output payment corresponding to the disbursement transaction is generated only if a payee character string of the disbursement transaction does not match any of the comparison character strings (e.g. only if the payee character string of the disbursement transaction is unique from each of the comparison character strings). Alternatively, a match transaction is generated if the payee character string of the disbursement transaction matches any of the comparison character strings.

The method may further comprise receiving an override transaction in response to generating a match transaction and generating the output payment in response to receiving the over ride transaction. The process of receiving the override transaction may comprise: i) receiving a login request from a remote override system; ii) authenticating an authorized user of the remote override system; iii) providing a manual data entry document including the match transaction to the override system; and iv) receiving the override transaction back from the remote over ride system.

Again, exemplary output payments include an Automated Clearing House compliant transaction and a printed draft affected by generating an image file comprising an image of a negotiable document for printing on a laser printer.

A third aspect of the present invention is to provide a system for receiving a disbursement transaction and verifying that a payee character string of the disbursement transaction is not a Specially Designated National.

The system comprises a Specially Designated National input system for obtaining a list of a plurality of Specially Designated Nationals. Each Specially Designated National is represented by a Specially Designated National character string. A comparison file generation system develops a plurality of alternative character strings. Each of the plurality of alternative character strings associates with one of the Specially Designated National character strings and represents the same Specially Designated National. A disbursement processing system obtains the disbursement transaction from a remote transaction source. An authorization module comprises a comparison engine which compares the payee character string to each of the comparison character strings to determining that the payee is not a Specially Designated National—if the payee character string does not match any of the comparison character strings. The authorization module further generates a disbursement authorization corresponding to the disbursement transaction in response to determining that the payee is not a Specially Designated National.

The authorization module may include an override module for generating a match transaction to a remote override system in response to the comparison engine determining that the payee character string matches a comparison character string. The override module may further provide for: i) receiving a login request from a remote override system; ii) authenticating an authorized user of the remote override system; iii) providing a manual data entry document including the match transaction to the override system; and iv) receiving an override transaction back from the remote override system. In which case, the override module may generate the disbursement authorization corresponding to the disbursement transaction in response to receiving an override transaction back from the override system.

The disbursement processing system may generate an output payment corresponding the disbursement transaction in response to receiving the disbursement authorization. Exemplary output payments generated in response to the disbursement authorization may be a wire transfer, an Automated Clearing House compliant transaction, another real time electronic settlement, and a printed draft effected by generating an image file comprising an image of a negotiable document for printing on a laser printer.

A fourth aspect of the present invention is to provide a system for processing a disbursement transaction received from an accounting system. The system may comprise a Specially Designated National input system for obtaining a list of a plurality of Specially Designated Nationals. Each Specially Designated National may be represented by a Specially Designated National character string. A comparison file generation system provides for: i) developing a plurality alternative character strings, each of the plurality of alternative character strings associating with one of the Specially Designated National character strings and representing the same Specially Designated National; and ii) developing a list of comparison character strings, the comparison character strings being each of the plurality of Specially Designated National character strings and each of the plurality of alternative character strings. A disbursement processing system receives the disbursement transaction from the accounting server. An authorization module comprises a comparison engine which compares a payee character string of the disbursement transaction to each of the comparison character strings and provides an indication of whether the payee character string matches any of the comparison character strings. The disbursement processing system generates an output payment corresponding to the disbursement transaction only if the payee character string of the disbursement transaction does not match any of the comparison character strings (e.g. the payee character string of the disbursement transaction is unique of all of the comparison character strings).

The authorization module may further comprises an override module for generating a match transaction if the payee character string of the disbursement transaction matches one of the comparison character strings. The override module further provides for: i) receiving a login request from a remote override system; ii) authenticating an authorized user of the remote override system; iii) providing a manual data entry document including the match transaction to the override system; and iv) receiving an override transaction back from the remote override system.

In which case, the disbursement processing system generates an output payment corresponding to the disbursement transaction in response to the override module receiving an override transaction back from the remote override system.

Again, the exemplary payment transactions generated in response to the disbursement authorization may be a wire transfer, an Automated Clearing House compliant transaction, another real time electronic settlement, and a printed draft effected by generating an image file comprising an image of a negotiable document for printing on a laser printer.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram illustrating architecture of an automated disbursement system with Office of Foreign Asset Compliance in accordance with one embodiment of the present invention;

FIG. 2 is a table representing exemplary fields of a disbursement transaction in accordance with one embodiment of the present invention;

FIG. 3 is a table representing exemplary character variations in accordance with one embodiment of the present invention;

FIG. 4 is a flow chart representing exemplary operation of a comparison file generation module in accordance with one embodiment of the present invention; and

FIG. 5 is a flow chart representing exemplary operation of a disbursement processing system in accordance with one embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

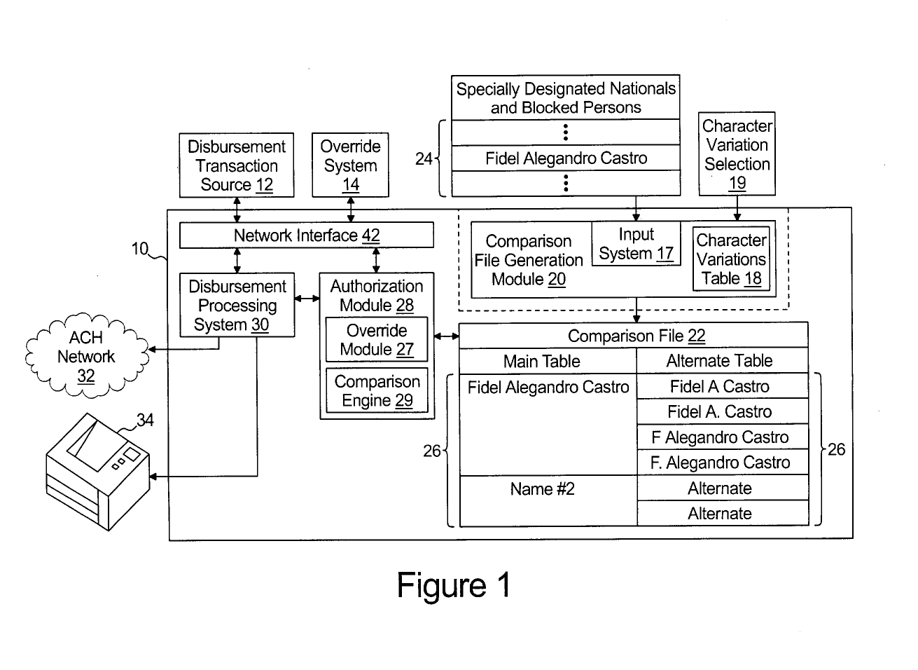

FIG. 1 illustrates exemplary architecture of an automated disbursement system with Office of Foreign Asset Compliance 10. The disbursement system 10 comprises a disbursement processing system 30, an authorization module 28, a network interface 42, a comparison file 22, and a comparison file generation module 20. The comparison file generation module 20 may be part of the system 10 or may be a separate system that provides the comparison file 22 to the system 10.

In operation, the disbursement system 10 receives a disbursement transaction from a disbursement transaction source 12. The disbursement transaction source 12 may be an accounting database system that automatically generates disbursement transactions from the data stored therein or may be a remote disbursement transaction input terminal wherein a user would authenticate to the disbursement system 10 and utilize a manual data entry screen to enter a disbursement transaction.

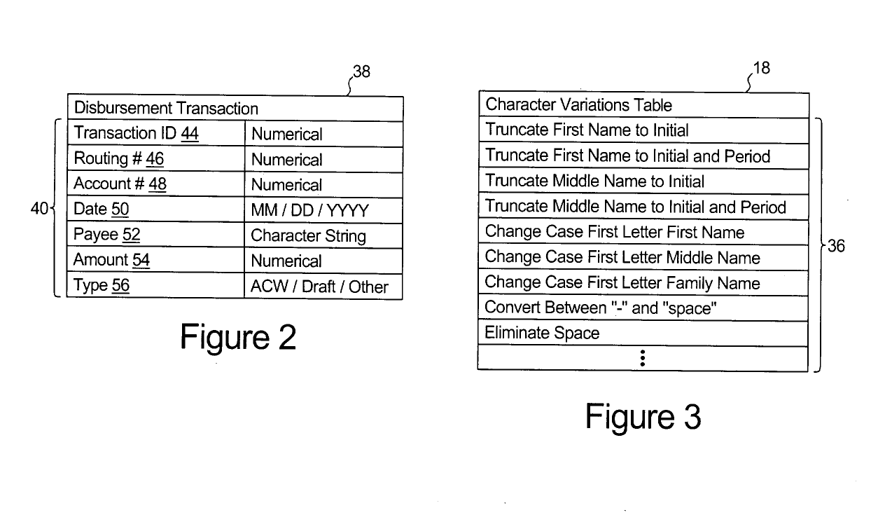

Referring briefly to FIG. 2, an exemplary disbursement transaction 38 is represented in table format. The disbursement transaction 38 comprises a plurality of fields 40 defining the disbursement. In the exemplary embodiment, the fields 40 comprise at least the fields necessary to complete a negotiable instrument and at least the fields necessary to generate an Automate Clearing House (ACH) transaction. Exemplary fields would include a disbursement transaction ID number 44, a routing number identifying the financial institution holding the account from which the disbursement is to be made 46, an account number from which the disbursement is to be made 48, a date 50, a character string identifying the payee of the disbursement 52, an amount of the disbursement 54, and an identification of the type of disbursement to be made 56. The identification of the type of disbursement to be made 56 may include an identifier that the disbursement is to be affected using an ACH payment or effected by printing a draft to the payee 52.

Returning to FIG. 1, after the disbursement processing system 30 receives the disbursement transaction 38, the disbursement processing system 10 must confirm that the payee is not a Specially Designated National. A Specially Designated National is a blocked person or entity identified by the United States Treasury Office of Foreign Asset control. Regulations prohibit releasing funds of, or releasing funds to, any Specially Designated National. The Office of Foreign Asset Control periodically releases lists of Specially Designated Nationals. The Specially Designated National List 16 represents such a list in a format wherein each record 24 is a character string representing a single Specially Designated National.

To effect the confirmation that the payee is not a Specially Designated National, the comparison engine 29 of the authorization module 28 compares the character string representing the payee of the disbursement 52 with each record 26 of the comparison file 22. The comparison file 22 includes a main table or list 22a and an alternate table or list 22b.

Each record 26 of the comparison file 22 comprises either: i) a character string that is either a character string from the main table 22a which is one of the records 24 of the list 16 of Specially Designated Nationals; or ii) an alternative character string from the alternate table 22b which is a character string from one of the records 24 with one or more character variations representing the same Specially Designated National from which it was derived. The one or more character variations of the alternative character string are common and non-substantive case, punctuation, and spacing variations that, while technically different than the character string of the record 24, do not alter the substantive name of the Specially Designated National represented by the record 24. Following the comparison engine 29 confirming that the payee is an authorized payee (e.g. that the payee is not a Specially Designated National)- or more specifically, following the comparison engine 29 confirming that a character string representing the payee is unique from each of the character strings that is either a character string from one of the records 24 or an alternative character string, then the authorization module 28 provides a disbursement authorization to the disbursement processing system 30 which, in turn, generates an output payment. The output payment may be an ACH transaction transmitted on an ACH network 32 or may be an image file, such as a PCL file, for transmission to a laser check printer 34.

Alternatively, if the comparison engine 29 is unable to confirm that the payee is not a Specially Designated National by comparison of the character string of the payee 52 to each record 26 of the comparison file 22 (e.g. the character string of the payee 52 matches a character string of a record 26), then an override module 27 of the authorization module 28 generates a match transaction to an override system 14.

The override system 14 may be a remote computer terminal. The match transaction may include all of the data files of the disbursement transaction 38 and an indication of the Specially Designated National to which the payee character string 52 matches. An authorized user of the override system 14 may authorize the disbursement even if the comparison engine 28 found a match between the payee 52 and a record 26 of the comparison file 22. This may happen in situations where a legitimate business partner of the corporate or financial institution operating the system 10 has the same name as, or a similar name to, a Specially Designated National and the authorized user of the override system 14 can, independently of the system 10, verify that the disbursement is to the legitimate business partner.

Following the override module 27 receiving a manually entered confirmation, the authorization module 28 provides a disbursement authorization to the disbursement processing system 30 which, in turn, generates the output payment.

To effect such operation, the various components of the exemplary system 10 may have structure and interaction as follows.

The network interface 42 may be a known combination of network interface circuits operating the physical, media access, and TCP/IP higher level systems for providing application layer communication between each of the disbursement processing system 30 and the authorization module 28 of the system 10 and each of the disbursement transaction source 12 and the authorization module 28 which may be remote from the system 10.

The authorization module 28 includes the comparison engine 29 and the override module 27. The authorization module 28 includes known systems for receiving a payee character string 52 from the disbursement processing system 30 and returning a disbursement authorization to the disbursement processing system 30, both using know inter-application communications. The comparison engine 29 may include known systems for matching character strings. The override module 27 may include known web server systems that provide for establishing a TCP/IP session with the override system 14 as a client upon receipt of a logon and authentication request from a user of the override system 14. The override module 27 may authenticate the user, provide an HTML document that includes the match transaction to the override system 14, and receive an HTTP post transaction back from the override system 14 that may include a manually entered confirmation that the payee 52 of the disbursement transaction 38 is not the Specially Designated National—but another individual or entity who has the unfortunate experience of having the same name of the Specially Designated National.

The comparison file generation module 20 includes a character variations table 18 and a Specially Designated National input system 17. The Specially Designated National Input system 17 may be a known system for receiving each record 24 of the Specially Designated National file 16 in one of a plurality of known file formats available from the US Treasury.

Referring briefly to FIG. 3, exemplary character variations 36 are represented by the character variation table 18. Character variations include permutations of one or more character variations which do not substantively alter the identity of the Specially Designated National. Exemplary variations include: i) truncating the Specially Designated National's first name to a single initial; ii) truncating the Specially Designated National's first name to a single initial and adding a period; iii) truncating the Specially Designated National's middle name to a single initial; iv) truncating the Specially Designated National's middle name to a single initial and adding a period; v) changing the case of the Specially Designated National's first name or first name initial; vi) changing the case of the Specially Designated National's middle name or middle name initial; vii) changing the case of the Specially Designated National's family name; viii) converting between a “space” and a “-” (or other character) an any of a Specially Designated National's first, middle, or family name; and ix) eliminating a “space” (or other character) in or between any of a Specially Designated National's first, middle, or family name. The character variations are input from a remote terminal 19 either on a per variation basis or as a variation file representing a plurality of variation algorithms.

Returning to FIG. 1, the comparison file 22 is generated by the comparison file generation module 20. The comparison file generation module 20 receives as inputs: i) the records 24 of the list 16 representing the Specially Designated Nationals; and ii) a selection 19 of character string variations 36 of the character string variation table 18 to apply to each of the records 24 to generate the alternative character strings. The alternate table 22b of the comparison file 22 is the output of the comparison file generation module 20.

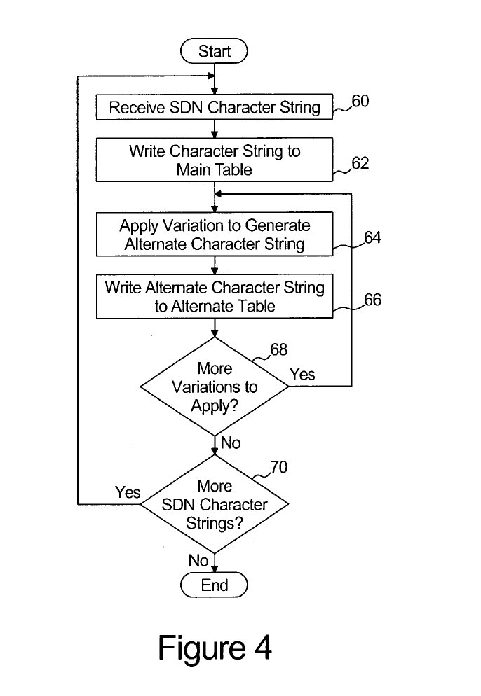

Referring briefly to FIG. 4, a flow chart representing an exemplary system for generating the comparison file 22 is shown. Step 60 represent receiving a character string representing a Specially Designated National and step 62 represents writing such character string to the main table 22a of the comparison file 22.

Step 64 represents applying a first of a plurality of character variations from the character variations table 18 to the character string to generate an alternate character string. Step 66 represents writing the alternate character string to the alternate table 22b of the comparison file 22.

Steps 64 and 66 are repeated for each variation within the character variations table 18. This repeating for each variation is represented by decision box 68 and the loop back to step 64.

Steps 60 through 66 are repeated for each record 24 of the Specially Designated National file 16. This repeating is represented by the decision box 70 and the loop back to step 60.

The disbursement processing system 30 includes known systems for receiving a disbursement transaction 38, combining the contents of the disbursement transaction 38 with proprietary authorizations, and generating one of an ACH payment transaction and an image file (such as a PCL file) for printing a draft on a laser check printer. An exemplary system is the PayBase® system available from Bottomline Technologies of Portsmouth, N.H.

In addition to such payment systems, the disbursement processing system 30 includes systems for transferring the character string of the payee 52 of the disbursement transaction 38 to the authorization module 28, receiving an authorization from the authorization module 28, and only providing the output payment when an authorization from the authorization module 28 has been received. The transfer of the character string of the payee 52 to the authorization module 28 and receiving an authorization from the authorization module 28 may be performed using known inter-application transfers—such as processing calls.

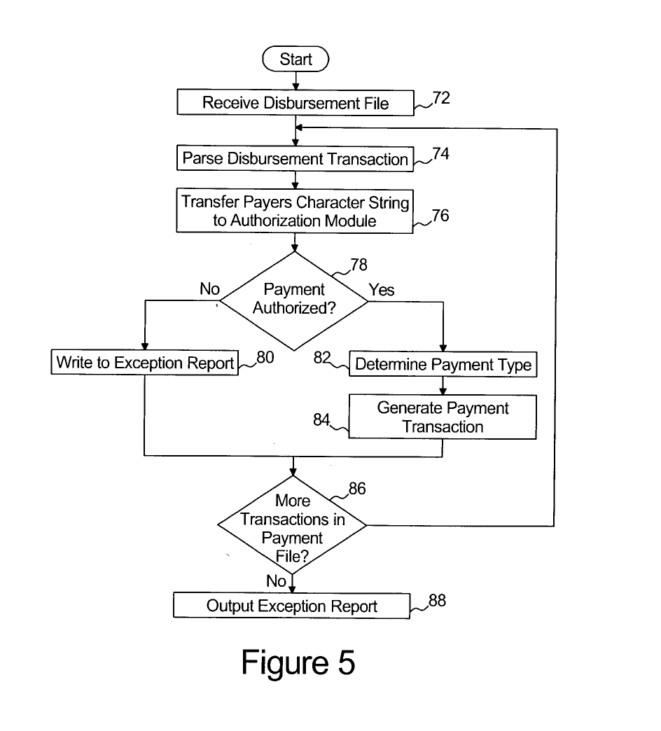

The flow chart of FIG. 5 represents exemplary operation of the disbursement processing system. Step 72 represents receipt of a disbursements file from the disbursement transaction source 12. This may be performed by receiving a log on request from the disbursement source 12 via the network interface 42, authenticating the disbursement transaction source 12, and receiving the disbursement transaction file from the disbursement source 12.

Step 74 represents parsing the disbursement transaction and step 76 represents transferring the payee character string to the authorization module 28. If no authorization is received from the authorization module 28 at step 78, the disbursement is written to an exception report file at step 80. If an authorization is received from the authorization module 28 at step 78, then at step 82 the payment type is determined. The payment type will typically be determined based on a field within the disbursement transaction 38. Exemplary payment types are ACH payments and laser check payments. Step 84 represents generating the output payment which includes generating the ACH transaction on the ACH network 32 (or other network for transmission to a banking institution coupled to the ACH network 32) or generating the image file for the laser printer 34.

The steps 74 through 84 are repeated for each disbursement transaction 38 within the disbursement file. This repeating is represented by decision step 86 and its loop back to step 74.

Step 88 represents outputting the exceptions report which represents each of the non-authorized disbursements wherein the payee character string matched one of the comparison character strings and for which override authorization was not provided.

In summary, the above described systems and methods provide an automated system for executing disbursement transactions and maintaining compliance with the Treasury Department's Office of Foreign Asset Control. Although the invention has been shown and described with respect to certain preferred embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of the modular multi-media communication management system of the present invention. The present invention includes all such equivalents and modifications, and is limited only by the scope of the following claims.

What is claimed is:

1. A method of receiving a disbursement transaction from an accounting system and verifying that a payee character string of the disbursement transaction is not a Specially Designated National, the method comprising:
obtaining a list of a plurality of Specially Designated Nationals, each Specially Designated National being represented by a Specially Designated National character string;
for each Specially Designate National character string, developing a plurality of alternative character strings that represent the Specially Designated National;
developing a comparison file, the comparison file comprising a plurality of comparison character strings, the plurality of comparison character strings being each of the plurality of Specially Designated National character strings and each of the plurality of alternative character strings;
receiving the disbursement transaction from the accounting system; and
comparing the payee character string to each of the comparison character strings to determining that the payee is not a Specially Designated National only if the payee character string does not match any of the comparison character strings.

2. The method of claim 1, further comprising generating an output payment corresponding to the disbursement transaction in response to determining that the payee is not a Specially Designated National.

3. The method of claim 1, further comprising generating a match transaction if the payee character string matches any of the comparison character strings.

4. The method of claim 3, further comprising:
receiving an override transaction in response to generating the match transaction; and
generating an output payment corresponding to the disbursement transaction in response to receiving the override transaction.

5. The method of claim 4, wherein the step of receiving the override transaction comprises:
receiving a login request from a remote override system;
authenticating an authorized user of the remote override system;
providing a manual data entry document including the match transaction to the override system; and
receiving the override transaction back from the remote override system.

6. The method of claim 5, wherein the output payment is at least one of an Automated Clearing House compliant transaction and an image file comprising an image of a negotiable document for printing on a laser printer.

7. A method of processing a disbursement transaction received from an accounting system, the method comprising:
obtaining a list of a plurality of Specially Designated Nationals, each Specially Designated National being represented by a Specially Designated National character string;
for each Specially Designate National character string, developing a plurality of alternative character strings that represent the Specially Designated National;
developing a comparison file, the comparison file comprising a plurality of comparison character stings, the plurality of comparison character strings being each of the plurality of Specially Designated National character strings and each of the plurality of alternative character strings;
receiving the disbursement transaction from the accounting system; and
generating an output payment corresponding to the disbursement transaction only if a payee character string of the disbursement transaction does not match any of the comparison character strings.

8. The method of claim 7, further comprising:
generating a match transaction if the payee character string of the disbursement transaction matches any of the comparison character strings.

9. The method of claim 8, further comprising:
receiving an override transaction in response to generating a match transaction; and
generating the output payment in response to receiving the override transaction.

10. The method of claim 9, wherein the step of receiving the override transaction comprises;
receiving a login request from a remote override system;
authenticating an authorized user of the remote override system;
providing a manual data entry document including the match transaction to the override system; and
receiving the override transaction back from the remote over ride system.

11. The method of claim 10, wherein the output payment is an Automated Clearing House compliant transaction.

12. The method of claim 10, wherein the output payment is an image file comprising an image of a negotiable document for printing on a laser printer.

13. A system for receiving a disbursement transaction and verifying that a payee character string of the disbursement transaction is not a Specially Designated National, the system comprising:
a Specially Designated National input system for obtaining a list of a plurality of Specially Designated Nationals, each Specially Designated National being represented by a Specially Designated National character string;
a comparison file generation system for developing a plurality of alternative character strings, each of the plurality of alternative character strings associating with one of the Specially Designated National character strings and representing the same Specially Designated National;
a disbursement processing system for obtaining the disbursement transaction; and
an authorization module comprising a comparison engine for comparing the payee character string to each of the comparison character strings to determining that the payee is not a Specially Designated National only if the payee character string does not match any of the comparison character strings.

14. The system of claim 13, wherein the authorization module further generates a disbursement authorization corresponding to the disbursement transaction in response to determining that the payee is not a Specially Designated National.

15. The system of claim 14, wherein the authorization module further comprises an override module for generating a match transaction in response to the comparison engine determining that the payee character string matches a comparison character string.

16. The system of claim 15, wherein the override module further provides for:
receiving a login request from a remote override system;
authenticating an authorized user of the remote override system;
providing a manual data entry document including the match transaction to the override system; and
receiving an override transaction back from the remote override system.

17. The system of claim 16, wherein the override module further generates the disbursement authorization corresponding to the disbursement transaction in response to receiving an override transaction back from the override system.

18. The system of claim 17, wherein the disbursement processing system further generates an output payment corresponding the disbursement transaction in response to receiving the disbursement authorization.

19. The system of claim 18, wherein the output payment is at least one of an Automated Clearing House compliant transaction and an image file comprising an image of a negotiable document for printing on a laser printer.

20. A system for processing a disbursement transaction received from an accounting system, the system comprising:
a Specially Designated National input system for obtaining a list of a plurality of Specially Designated Nationals, each Specially Designated National being represented by a Specially Designated National character string;
a comparison file generation system for:
developing a plurality alternative character strings, each of the plurality of alternative character strings associating with one of the Specially Designate National character strings and representing the same Specially Designated National; and
developing a list of comparison character strings, the comparison character strings being each of the plurality of Specially Designated National character strings and each of the plurality of alternative character strings;
a disbursement processing system for receiving the disbursement transaction from the accounting system;
an authorization module comprising a comparison engine for comparing a payee character string of the disbursement transaction to each of the comparison character strings and providing an indication of whether the payee character string matches any of the comparison character strings; and
the disbursement processing system generating an output payment corresponding to the disbursement transaction only if the payee character string of the disbursement transaction does not match any of the comparison character strings.

21. The system of claim 20, wherein the authorization module further comprises an override module for generating a match transaction if the payee character string of the disbursement transaction matches one of the comparison character strings.

22. The system of claim 21, wherein the override module further provides for:
receiving a login request from a remote override system;
authenticating an authorized user of the remote override system;
providing a manual data entry document including the match transaction to the override system; and
receiving an override transaction back from the remote override system.

23. The system of claim 22, wherein the disbursement processing system further generates an output payment corresponding to the disbursement transaction in response to the override module receiving an override transaction back from the remote override system.

24. The system of claim 23, wherein the output payment is at least one of an Automated Clearing House compliant transaction and an image file comprising an image of a negotiable document for printing on a laser printer.
